(19) United States
(12) Patent Application Publication
(10) Pub. No.: US 2003/0019674 A1
(43) Pub. Date: Jan. 30, 2003

(54) Hybrid electric all-wheel-drive system

(76) Inventor: Zhihui Duan, Erie, PA (US)

Correspondence Address: Zhihui Duan, 5317 LaRae Drive, Erie, PA, 16506, US

(21) Appl. No.: 10/206,867

(22) Filed: Jul. 27, 2002

Related U.S. Application Data
(60) Provisional application No. 60/308,484, filed on Jul. 28, 2001.

(51) Int. Cl. B60K 1/00

(52) U.S. Cl. 180/65.3

(57) ABSTRACT

The hybrid electric all-wheel-drive (HEAWD) system comprises a heat engine, a transmission, an integrated starter/alternator (ISA), a motor control module (MCM), a traction motor (TM), and a battery pack. The engine drives either the front wheels or the rear wheels, and TM drives the other pair of wheels. ISA starts and assists the engine or generates electricity. Both ISA and TM apply braking torque on the wheels and regenerate the vehicle kinetic energy into electricity during deceleration. MCM provides electric current to and controls both ISA and TM to work in their desired working modes. The battery stores the electric energy generated by the motors and provides electric power to the motors. A double-rotor traction motor provides the functions of a conventional traction motor plus an axle differential/torque coupling device.

### CROSS-REFERENCE TO RELATED APPLICATIONS

This application claims the benefit of PPA Ser. No. 60/308,484, filed Jul. 28, 2001 by the present inventor.

### FEDERALLY SPONSORED RESEARCH

Not Applicable

### SEQUENCE LIST OR PROGRAM

Not Applicable

### TECHNICAL FIELD

This invention relates to hybrid-electric all-wheel-drive system for passenger cars and light trucks. More particularly, this invention relates to a hybrid electric all-wheel-drive system that, with significantly improved fuel economy, is fully competitive with conventional all-wheel-drive system in regard of performance and cost.

### BACKGROUND OF THE INVETION

A hybrid electric drive system typically comprises an engine, a transmission, an electric motor, a motor controller, and a battery package. The engine provides torque to wheels as well as to the motor to generate electric power. The motor has two functional modes of motoring and generating determined by the motor controller. The motor may start the engine, assist the engine to accelerate the vehicle, generate electric power using engine torque, or regenerate kinetic energy into electric power, depending on the need. The motor controller sets motor's function mode by providing power to the motor. The battery stores electric energy generated by the motor and provides electric energy to the motor.

Some hybrid drive systems have more than one motor and controller.

Naturally and logically, hybrid electric all-wheel-drive systems are developed to improve the fuel efficiency of all-wheel-drive vehicles.

The most straightforward way to building a hybrid-electric all-wheel-drive vehicle is connecting a mechanical all-wheel-drive system to a hybrid-electric drive system, and the major advantage is that the technologies for mechanical all-wheel-drive system is mature. A mechanical all-wheel-drive system comprises a transfer case and a drive shaft to the rear axle differential. The transfer case takes a bulk of volume, and the drive shaft requires a channel from the transmission to the rear axle, so the system takes a large amount of space and weight. The drive shaft channel also limits the flexibility of the vehicle layout.

An electric-all-wheel-drive (E-AWD) system comprises an alternator and a traction motor (Page 60, Dec, 2001, WARD'S AUTO WORLD). The alternator is connected to the engine shaft which also drives the front wheels. The alternator is actuated only when front wheels slip, providing power to the traction motor, and the traction motor provides torque to the rear wheels. The electric motor is turned off when no slippage occurs, and so the fuel efficiency is improved. This system is not a hybrid-electric drive system and can not provide extra torque to assist the engine by using electric power from the battery.

A system is proposed to use an electric motor to drive either front wheels or rear wheels while the IC engine drives the others (U.S. Pat. No. 5,788,005). The system uses the electric motor to pull the vehicle out of still when the engine driven wheels slip, and the system is not expensive because it uses a direct current (DC) motor and does not need an inverter. The drawback of this system is that the DC traction motor requires regular maintenance.

A hybrid 4-wheel-drive system uses a traditional engine and transmission to drive one pair of wheels and a motor to drive the other pair of wheels (Matthew Wald, Oct. 10, 2001, New York Times). There is a battery and a controller. The motor generates electric energy using the torque from the wheels while no slippage occurs, and the battery stores the electric energy. When the engine-driven wheels slip, the battery will power the motor to drive the other pair of wheels. This system can provide extra torque to assist the engine by using the energy stored in the battery, and vehicle's kinetic energy can be regenerated into electricity during deceleration, improving fuel efficiency. The motor is a poly-phase alternating current (AC) motor, and it does not need regular maintenance. In this system, however, there is no internal channel for the engine to deliver power to the motor, so the motor can not work if the energy in the battery is used up.

Another system comprises two AC motors and two controllers (U.S. Pat. No. 6,059,064). One of the motors is connected to the engine shaft to start the engine and to generate electric power. The engine drives one pair of wheels, and the second motor drives the other pair of wheels. In this system, the first motor converts mechanical energy from the engine into electric power, and delivers it to the battery. The second motor uses the electric energy stored in the battery, so the second motor can get the power it needs all the time. In this system, each motor needs one controller, and the controller which includes an inverter is very expensive, so the cost for this system is high.

In regard of traction motors, most hybrid electric all-wheel-drive systems use a single-rotor poly-phase AC motor connected to an axle differential, and the differential splits the torque to the two wheels. The differential has a main drawback: if one of the two wheels slips, the differential is unable to deliver torque to the other wheel, and this pair of wheels can not drive the vehicle. So the vehicle's performance is degraded under bad road conditions.

A torque coupling device may be used to improve the performance. If one of the two wheels slips, the torque coupling device is able to deliver torque to the other, gripping wheel, so this pair of wheel still can drive the vehicle. The torque coupling device is expensive and has negative impact on the fuel efficiency.

Varela, Jr. proposed double-rotor motors with permanent magnet rotors for a hybrid electric drive system. He also proposed a cylinder-type double rotor induction motor (U.S. Pat. No. 5,172,784). A permanent magnet motor is more expensive than an induction motor, and it requires a more complex control system. A ylinder-type induction motor has its advantages, but it weighs more than disk-type motors because of its low utilization factor of core material. Also cylinder-type motors may not be suitable to some situations where other types of motors can do better jobs. For example, when the axial dimension is limited, disk-type motors can provide more torque than cylinder-type motors.

### SUMMARY OF THIS INVETION

A main objective of the present invention is to provide a hybrid electric all-wheel-drive (HEAWD) system for passenger cars and light trucks.

The system comprises a heat engine, an integrated starter/alternator (ISA), a traction motor (TM), a motor control module (MCM), and a battery.

The heat engine drives either the front wheels or the rear wheels, and the traction motor (TM) drives the other pair of wheels. For description convenience, the engine is said to drive the front wheels, and TM to drive the rear wheels. The transfer case and the drive shaft in a mechanical all-wheel-drive system are replaced by TM and its wiring.

ISA is a poly-phase alternating current (AC) motor. It starts the engine and generates electric power. It also provides braking torque while regenerating vehicle's kinetic energy into electric energy during deceleration.

The traction motor (TM) provides drive force to the rear wheels when extra drive is needed and when the front wheels slip. Also TM provides braking torque to the rear wheels while converting vehicle's kinetic energy into electric energy during deceleration.

The motor control module (MCM) converts direct current into alternating current to run the motors. Typically each motor needs its own controller to provide AC power, and, unfortunately, the semiconductor inverter in MCM is very expensive. The present invention provides solutions for one MCM to provide AC power for both ISA and TM.

The battery stores the electric energy generated by the motors and provides electric power for them to create torque.

Another objective of the present invention is to provide a disk-type double-rotor motor as the traction motor. The rotors are independent of each other, and each rotor is connected to one rear wheel, allowing the wheels to run at different speeds and eliminating the need for a differential. If one of the two wheels slips, the double-rotor motor delivers more torque to the gripping wheel, enhancing vehicle's performance.

In brief, this invention provides a hybrid electric all-wheel-drive system for passenger cars and light trucks. The system uses two electric motors to start and assist the engine and regenerate vehicle's kinetic energy into electric energy for storage, providing good fuel efficiency. The traction motor replaces the conventional transfer case and drive shaft, making the channel for the drive shaft unnecessary. Only one motor controller (inverter) is used to control the two motors while similar system needs two inverters to do the same job, a significant cost saving. This invention also provides a double-rotor traction motor for better performance under bad road conditions, and the rear differential or torque coupling device is eliminated.

### BRIEF DESCRIPTION OF THE DRAWINGS

FIG. 1 illustrates Preferred Hybrid Electric All-Wheel-Drive system (HEAWD) Embodiment I wherein ISA is switched between the engine shaft and the transmission output shaft.

FIG. 2 illustrates Preferred HEAWD System Embodiment II wherein ISA is connected to a rectifier, and MCM control TM when the engine is in operation.

FIG. 3 illustrates Preferred HEAWD System Embodiment III wherein ISA is connected the transmission output shaft, and a clutch is between ISA and the front axle.

FIG. 4 illustrates Preferred HEAWD System Embodiment IV wherein multi-speed ISA and TM are used for keeping the two motors electrically synchronous.

FIG. 5 illustrates Preferred HEAWD System Embodiment V wherein multi-speed ISA and TM are used and the transmission is eliminated.

FIG. 6 illustrates Preferred Double-Rotor Traction Motor Embodiment wherein two disc-type rotors are sandwiched by the two pieces of the stator.

FIG. 7 illustrates Alternative Double-Rotor Traction Motor Embodiment wherein the stator is sandwiched by two disc-type rotors.

### DETAIL DESCRIPTION OF THE INVENTION

The hybrid electric all wheel drive (HEAWD) system comprises a heat engine, a transmission, an integrated starter/alternator (ISA), a motor control module (MCM), a traction motor (TM), and a battery.

The heat engine drives either the front wheels or the rear wheels, and the TM drives the other pair of wheels. For description convenience, the engine is said to drive the front wheels, and TM to drive the rear wheel.

ISA is a poly-phase alternating current (AC) motor, and it starts the engine and assists the engine to drive the vehicle when needed. It also generates electricity when needed no matter whether the vehicle is moving or standstills. To do those, ISA should be able to connect to engine any time and to disconnect from the wheels when needed.

TM is a poly-phase AC induction motor, and it is connected to the rear wheels. TM drives the rear wheels when a drive effort is needed. It provides braking torque to the rear wheels to slow down the vehicle and, at the same time, regenerates the vehicle's kinetic energy into electricity for storage.

TM is either a single rotor or a double-rotor motor. For a single rotor TM, its shaft is connected to a differential or a torque coupling device, and the differential/coupling device in turn drives the rear wheels. A double-rotor TM has two independent rotors and a single rotating magnetic field created by its stator. Each rotor is connected one rear wheel, and the two rotors can rotate at different speed, allowing the vehicle to turn its direction.

MCM includes an inverter, control circuits and other components, and the inverter converts direct current (DC) from the battery into poly-phase an alternating current (AC). MCM can be connected to both ISA and TM at the same time or just connected to one of them, depending on the situation.

Going through the stator winding of an induction motor, the AC current creates a rotary magnetic field in the motor, and the rotation speed is called synchronous speed. When the synchronous speed is higher than the rotor speed, the machine works as a motor, consuming electric energy and creating mechanical torque. When the synchronous speed is lower than the rotor speed, the machine will work as an alternator, generating electric energy and applying braking torque.

Sometimes, ISA and TM work in different modes: one is generating while the other is motoring, as the situation when some wheel slips. The only MCM co-ordinates ISA and TM by adjusting the frequency of the alternating current.

The transmission changes its gear ratio for keeping the engine running in its most effective range over the vast speed range of the vehicle, so the speed ratio of the engine to the wheels changes when the gear changes. On the other hand, unless slippage occurs, the speed ratio of rear wheels to front wheels remains constant because the front wheels travel the same distance as the rear wheels. If TM is connected to the rear wheels and ISA is connected to the engine, the speed ratio of TM rotor to ISA rotor will change when the gear changes, and this may cause TM and ISA electrically asynchronous.

When ISA and TM are powered by a single AC supply, each motor has its own synchronous speed. Assume, through some gear sets, ISA is connected to the front wheels and TM connected to the rear wheels. If ISA's synchronous speed tends to drive the front wheels to travel the same distance as TM's synchronous speed tends to drive the rear wheels to travel, ISA and TM are said “electrically synchronous” to each other. Otherwise they are electrically asynchronous.

If only one inverter is used to control both ISA and TM at the same time, it is necessary for ISA and TM to be electrically synchronous. Other wise, the two motors can not be kept in desired working condition. This may cause bad performance, very bad fuel efficiency, and even the motors burned.

There are three ways to solve this problem: keep the speed ratio of ISA to TM constant, keep MCM from controlling ISA and TM at the same time, or keep ISA and TM electrically synchronous.

Five preferred system embodiments are provided to solve the asynchrony issue between ISA and TM. Also provided are two preferred embodiments of the double-rotor traction motor.

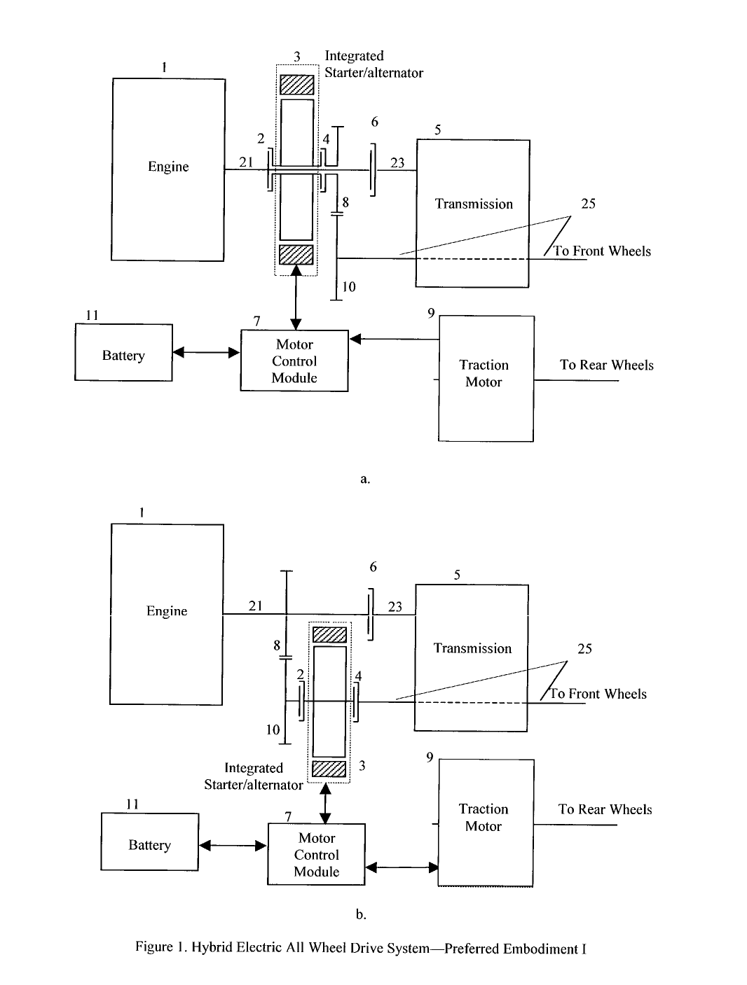

Preferred Hybrid Electric All-Wheel-Drive System Embodiment I—FIG. 1

The system comprises a heat engine (1), a transmission (5), an integrated starter/alternator (ISA) (3), a motor control module (MCM) (7), a traction motor (TM) (9), and a battery pack (11). The system is able to keep the speed ratio of ISA to TM constant, allowing MCM with one inverter to provide electric current to and control both ISA and TM at the same time.

Engine (1) provides torque through a clutch (6) to transmission (5), and the transmission's output shaft is connected to the front wheels. ISA (3) is sliding on engine shaft and can be connected to the shaft by a clutch (2). A gear (8) is also sliding on the engine shaft and can be connected to ISA rotor by a clutch (4). A gear (10) is mounted on transmission output shaft and always engaged with gear (8). When clutch (4) is engaged, ISA is connected to gear (8) and, in turn, connected to the transmission output shaft.

When clutch (4) is engaged, ISA rotor is connected to the front wheels, and the speed ratio of ISA to TM is constant when no slippage occurs. The system is so designed that ISA is electrically synchronous to TM in this situation. Since ISA and TM are electrically synchronous, a single MCM can control both motors at the same time.

For example, during acceleration, MCM provides such AC power that the synchronous speed of each motor is higher than its mechanical speed, so both motors take electric energy and output torque to the wheels. During deceleration, MCM provides such AC power that the synchronous speed is lower than the mechanical speed, so both motors take kinetic energy and generate electricity. When there is no need for either electric power or torque, MCM may set the motors' synchronous speed equal to the rotor speed or simply turn off the alternating current, and ISA and TM will run at idle.

An alternative layout is shown in FIG. 1b. where ISA is sliding on transmission output shaft. The principle is the same: ISA is connected either to engine or to transmission output. In fact, if ISA can be switched between engine shaft and transmission output shaft, it does not matter where ISA axle is.

Some combinations of ISA and TM working modes are listed as follows:

| Situation | ISA | TM | Clutch(2) | Clutch(4) |
|---|---|---|---|---|
| To start cold engine | Motor | Off line | Engage | Disengage |
| Generating while | Generator | Off line | Engage | Disengage |
| parking | | | | |
| Acceleration | Motor | Motor | Disengage | Engage |
| Deceleration | Generator | Generator | Disengage | Engage |
| Cruise | Generator or idle | | Disengage | Engage |
| Front wheels slip | Generator | Motor | Disengage | Engage |
| Rear wheels slip | Motor | Idle | Disengage | Engage |
| Front wheels and | Generator | One rotor | Disengage | Engage |
| a rear wheel ship | | motors and | | |
| (Double-rotor motor | | one idle | | |
| only) | | | | |

To start the engine, the system is set in start position: clutch (2) is engaged and clutch (4) is disengaged. MCM only provides AC power to ISA, and ISA rotor turns engine shaft.

While the engine is in operation and the vehicle stands still, the start position allows ISA to generate electricity under MCM control.

In all other situations like acceleration, deceleration, and cruise, the system is set in drive position: clutch (2) is disengaged, and clutch (4) is engaged. ISA rotor is connected to the transmission output shaft, and MCM can provide electric current to and control both ISA and TM at the same time.

Operation of the System:

When the key is turned on, clutch (2) is engaged, connecting ISA to engine shaft, and clutch (4) disengaged (Start position). TM is disconnected from MCM, and MCM powers ISA to start the engine.

When engine is in operation, MCM controls ISA to generate electricity if it is needed (start position).

When the gear is shifted to Reverse, clutch (2) is disengaged, and clutch (4) is engaged, connecting ISA to the transmission output shaft (Drive position). Now ISA is electrically synchronous to TM, and MCM is connected to both ISA and TM. When the driver steps on the accelerator, MCM outputs electric current to drive ISA and TM in reverse direction, and the two motors assist the engine to drive the vehicle backward.

When the transmission is shifted to Drive, clutch (2) and clutch (4) stay in the drive position, and ISA remains electrically synchronous to TM. MCM is connected to both ISA and TM. When the driver steps on the accelerator, MCM outputs electric current to drive ISA and TM in forward direction, and the two motors assist the engine to drive the vehicle forward.

When the vehicle comes into cruise, clutch (2) and clutch (4) stay in the drive position, and ISA remains electrically synchronous to TM. The engine torque is delivered to the front wheels through the transmission. When there is no need for either extra torque or electricity, MCM turns off the electric current to ISA and TM, and the motors idle. When electricity is needed, MCM will provide stimulation current to ISA and/or TM, and the motors will generate electricity of desired horsepower for accessory and/or for the battery to store. When the vehicle needs more torque, MCM will provide electric power for the motors to drive the wheels.

During deceleration, clutch (2) and (4) stay in the drive position, and ISA and TM stay electrically synchronous. MCM sets the AC frequency so that the synchronous speeds are lower than rotor speeds, so both ISA and TM output braking torque to the wheels and generate electricity for battery to store. MCM adjusts the frequency according to the brake panel position so that the braking torque meets driver's desire for braking effort. The motors output braking torque only when the wheels are rotating and will not lock the wheels.

If the front wheels slip, MCM will set such an AC frequency that optimizes TM's driving torque. Driven by the engine, ISA tends to run at a higher speed than the synchronous speed and therefore generate electricity. ISA also outputs torque to slow down the front wheels. The electric current from ISA has the same frequency as MCM's output current, so it goes to TM. TM drives rear wheels forward using the total electric power from battery and ISA.

For a single-rotor TM, when one of the rear wheels slips, the rotor does not tend to run very fast but tends to run at the synchronous speed. Running at the synchronous speed, TM takes little power from MCM, so ISA takes most of the AC power from MCM and assists the engine to drive the vehicle.

For a double-rotor TM, when one of the rear wheels slips, the respective rotor tends to run at synchronous speed. The rotor takes little power from MCM and provides no torque the wheel. At the same time, the other rotor takes most power that MCM provides to TM and drives the gripping wheel as if there is a coupling device between the two wheels.

When both rear wheels slip, both TM rotors tends to run at synchronous speed, and TM takes little power from MCM. Most of electric power that MCM provides goes to ISA, and ISA assists the engine to drive the vehicle.

It is obvious that even in the case that the front wheels and one of the rear wheels slip, the system is still able to drive the vehicle. So the double-rotor TM provides good performance under bad road conditions.

The system can also be so designed that the engine shuts down when the vehicle stops. In this system, TM and ISA drive the vehicle breakaway, and the engine starts when having reached ignition speed. In other situations, the system works in the same way as the system described above.

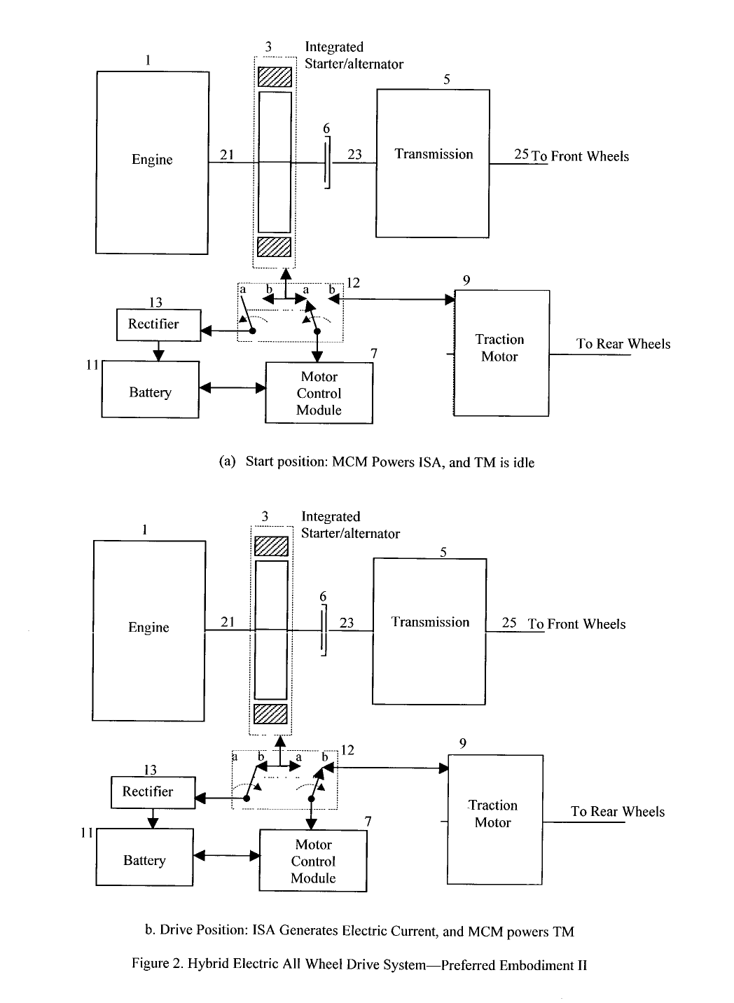

Preferred Hybrid Electric All-Wheel-Drive System Embodiment II—FIG. 2

The system comprises an engine (1), an integrated alternator/starter (ISA) (3), a transmission (5), a motor control module (MCM) (7), a traction motor (TM) (9), a battery package (11), and a rectifier (13) converting alternating current from ISA into direct current. In this system, MCM is not connected to ISA and TM at the same time.

ISA (3) is a permanent magnet motor, and the rotor is mounted on the engine (1) shaft and has the same speed as the engine all the time. When the transmission (5) changes gear, the speed ratio of the engine to the wheels changes, so the speed ratio of ISA to TM (9) changes. As a result, ISA and TM can not be kept electrically synchronous, and a single MCM can not power ISA and TM at the same time.

A double-throw switch (12) and the rectifier (13) enable a single MCM to control either ISA or TM, but not both at the same time. The switch (12) could be a part of MCM or other components.

Operation of the System—FIG. 2:

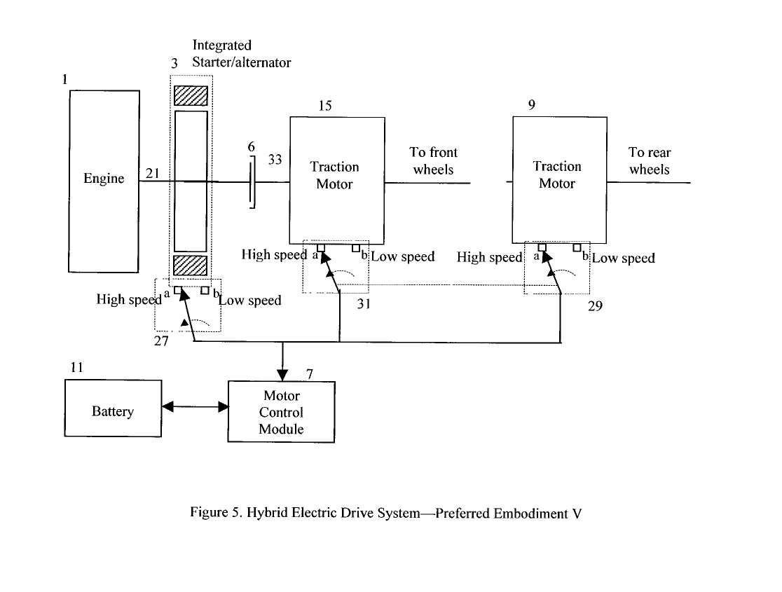

To start the engine, switch (12) is set to the start position: MCM is connected to ISA and disconnected from TM, and ISA is disconnected from rectifier (13). MCM provides electric current to ISA, and ISA turns the engine shaft. See FIG. 5(a).

After engine (1) is started, switch (12) is set in the drive position: MCM is connected to TM and disconnected from ISA (3), and ISA is connected to rectifier (13). MCM controls TM to drive or brake the rear wheels. ISA generates electricity, and the rectifier converts the AC electricity into DC electricity that goes to the battery (11). See FIG. 2(b).

To accelerate the vehicle, the engine drives the front wheels, and TM drives the rear wheels by using the electric power provided by MCM.

During cruise, MCM turns off TM, and the engine drives the vehicle. ISA generates a certain amount of electricity as needed.

To decelerate the vehicle, TM applies braking torque to the rear wheels, and ISA applies braking torque to the front wheels. At the same time, the two motors regenerate vehicle's kinetic energy into electric energy for storage.

If the front wheels slip, ISA generates electric power to the battery, and its output torque slows down the front wheels. MCM converts the direct current from the battery and ISA into AC power for TM, and TM drives the rear wheels.

If the rear wheels slip, the engine drives the front wheels, and the front wheels drive the vehicle. When extra torque is needed, switch (12) is set to starting position, and MCM provides power for ISA to boost the engine.

For a double-rotor TM, if only one rear wheel slips, the other wheel still can drive, same as that in HEAWD System Embodiment I.

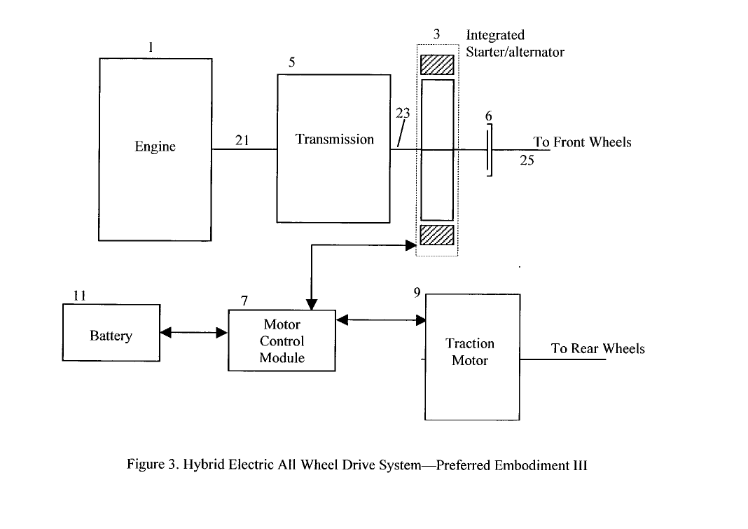

Preferred Hybrid Electric All-Wheel-Drive System Embodiment III—FIG. 3

The system comprises a heat engine (1), a transmission (5), and a starter/alternator (ISA) (3), a traction motor (TM) (9), a motor control module (MCM) (7), and a battery pack (11). This system is able to keep the speed ratio of ISA and TM constant, allowing MCM with one inverter to provide electric current to and control both ISA and TM.

In this system, the most significant characteristic is that ISA (3) is connected to the output shaft of the transmission, and the transmission has a clutch (6) between transmission (5) output shaft and the front wheel shaft. As a result, ISA always follows transmission's output speed no matter what the gear ratio is. In another word, the speed ratio of ISA to front wheels is constant. Since the speed ratio of front wheels to rear wheels is constant, the speed ratio of ISA to TM is unchanged, so the two motors will remain electrically synchronous if they are designed electrically synchronous.

The position of clutch (6) enables ISA to start the engine and generate electricity when vehicle standstills. To start the engine or to generate electricity when the vehicle standstills, clutch (6) is disengaged, separating the engine (1) and ISA (3) from the wheels, and MCM is connected to ISA and disconnected to TM. MCM controls ISA either to start the engine or to generate electricity.

Operation of the System—FIG. 3:

To start the engine, clutch (6) is disengaged, separating the engine (1) and ISA (3) from the wheels, and MCM is connected to ISA and disconnected from TM. MCM provides power for ISA to start the engine.

When the engine is in operation, MCM can control ISA to generate electricity for the vehicle.

When the transmission is set to reverse gear, MCM is connected to both ISA and TM and provides them with AC power in reverse direction, and both motors output reverse torque. TM torque goes to the rear wheels, and ISA torque, together with engine torque goes through clutch (6) to the front wheels.

When the vehicle accelerates forward, the transmission is set to a forward gear. MCM is connected to both ISA and TM and provides them with AC power in forward direction. TM torque goes to the rear wheels, and ISA torque, together with engine torque, goes through clutch (6) to the front wheels.

When the vehicle cruises, engine torque goes through the transmission (5) to the front wheels. If there is no need for electricity, MCM will turn off ISA and TM, and the motors will run idle. If electricity is needed for other equipment, MCM will provide ISA and TM with such electric current that the motors' synchronous speeds are lower than their speeds, and then ISA and TM will generate electricity.

When the vehicle decelerates, MCM controls ISA and TM to provide braking torque and convert the kinetic energy into electric energy for battery to store. MCM can set such a frequency that the motors' braking torque meets driver's desire for braking effort.

When slippage occurs, the scenarios are same as or similar to those in Preferred HEAWD System Embodiment I, and we won't repeat the description.

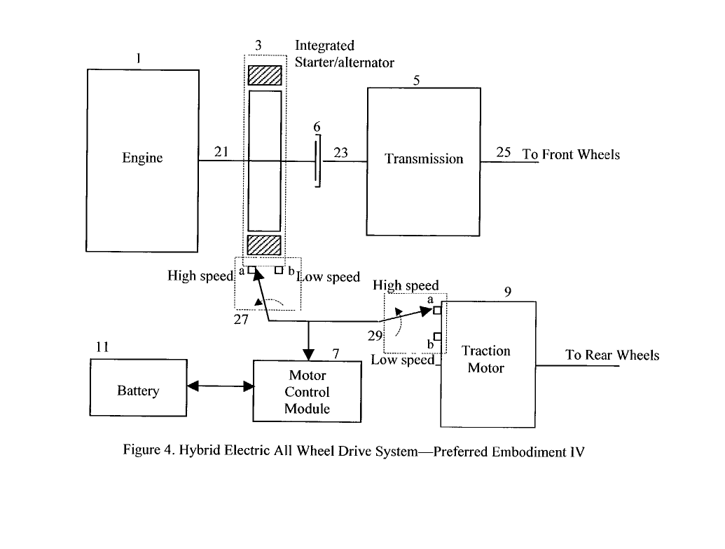

Preferred Hybrid Electric All-Wheel-Drive System Embodiment IV—FIG. 4

The system comprises an engine (1), an integrated starter/alternator (ISA) (3), a transmission (5), a motor control module (MCM) (7), a traction motor (TM) (9), and a battery (11). See FIG. 4. This system is able to keep ISA and TM electrically synchronous, allowing MCM with one inverter to provide electric current to and control both ISA and TM.

The rotor of ISA (3) is connected to the engine (1) shaft, and it always takes the speed of the engine. TM rotor is connected to the rear wheels, and it has a constant speed ratio to the transmission (5) output shaft. The transmission changes gear all the time, so the speed ratio of ISA to TM changes all the time. The two motors' synchronous speeds created by a single AC supply would drive the front wheels run at a different speed from the rear wheels, and it would overheat and damage the motors.

Multi-speed motors are used to solve the asynchrony issue caused by the gear changing.

A multi-speed induction motor has such a winding that can be re-grouped by changing the position of a switch, and the number of its poles is changeable. For a certain AC frequency, the synchronous speed of the motor changes if the number of the poles changes.

There are many different multi-speed induction motors, but here only two-speed motor with 2:1 speed ratio is discussed as an example, and other multi-speed motors can be used in a similar way. In this system, each of ISA and TM has two speeds, and the high speed is twice as high as the low speed. A switch (27) is used to set ISA's speed, and a switch (29) to set TM's speed. MCM controls the switches to set the speeds.

For a 2:1 two-speed motor, if it is shifted from the low speed to the high speed, its synchronous speed is doubled with the same current frequency. If it is shifted from the high speed to the low speed, its synchronous speed is reduced by half with the same current frequency. The motor's synchronous speed remains unchanged, if its speed is shifted from the low to the high, and the frequency is reduced by half at the same time. Similarly, if its speed is shifted from the high to the low, and the frequency is doubled, the motor's synchronous speed remains unchanged.

The transmission (5) has such gears that the second gear ration doubles the first gear ratio, the third gear ratio doubles the second gear ratio, and the reverse gear has the same ratio of as first gear but in opposite direction. For example, the transmission in the description has the gear ratios of 2.8:1, 1.4:1, 0.7:1, and 2.8:(−1).

Operation of the System—FIG. 4:

The system is so designed that ISA is electrically synchronous to TM when ISA is at the high speed (27a) and TM at the low speed (29b) as the transmission (5) is at first gear. It can be achieved by selecting the numbers of poles of motors and ratios of gears.

When the transmission is engaged to the first gear, the gear ratio is 2.8:1. ISA is set at the high speed (27a) and TM is set at the low speed (29b), so ISA and TM are electrically synchronous as the system is designed. So a single MCM can provide a certain frequency AC current to both motors so that both motors work at desired working point.

When the transmission is shifted from first gear to second gear, the engine and ISA speed is reduced by half. At the same time, TM is shifted up to the high speed (29a) from the low speed (29b), and the AC frequency is reduced by half. Now both synchronous speed and the mechanical speed of ISA are reduced by half, ISA stays in its correct working condition. TM is shifted from the low speed to the high speed, and the current frequency is reduced by half, so its synchronous speed is not changed. Connected to the rear wheels, TM speed is not changed. Since TM speed and TM synchronous speed remain unchanged, TM stays in its correct working condition. As a result, both ISA and TM are at their correct working condition at the new frequency, and MCM can control both motors at the same time.

When the transmission is shifted from second gear to third gear, the engine and ISA speed is reduced by half. This time, the current frequency is not changed, but ISA is shifted from the high speed (27a) to the low speed (27b), reducing ISA synchronous speed by half. Both ISA speed and ISA synchronous speed are reduced by half, ISA stays in its correct working condition. Since no change occurs to TM, TM stays in its correct condition. Now that both ISA and TM work at their own correct condition at the same frequency, MCM can provide current to and control both motors at the same time.

When the transmission is shifted to the reverse, the gear ratio is 2.8:(−1), same as that of first gear but in reverse direction. If ISA is set at the high speed (27a) and TM is set at the low speed (29b), then ISA and TM have the speed to be electrically synchronous, but they run in different directions. If either ISA or TM, but not both, running direction is reversed, the motors will be electrically synchronous. Swapping two of three power lines will change a poly-phase AC motor's direction. MCM can control an electric switch to change either ISA's or TM's direction, and ISA will be electrically synchronous to TM, so MCM can control both motors at the same time.

When slippage occurs, the scenarios are same as or similar to those in Preferred System Embodiment I.

Two-speeds motor with 2:1 speed ratio is discussed as an example to explain how the system works. Other multi-speed motors also can be used together with a customized transmission and provide more available speeds. For example, a two-speeds motor with speed ratio of 5:2 is used as ISA and a two-speeds motor with speed ration of 3:2 as TM, then the system can work with gear ratios of 2.5:1, 1.67:1, 1:1, 0.67:1, and 2.5:(−1).

The system may be simplified by using one multi-speeds motor and one single speed motor. In this system, MCM will control both motors at the same time only at the first, second and reverse gear (low gears). At high gears, ISA is not electrically synchronous to TM, and MCM can not control both motors at the same time. In these situations, MCM will disconnect one of the motors and only control the other motor to drive or to generate electricity. MCM is required to control both motors simultaneously only if slippage occurs and lasts long enough to use up the energy in the battery, but this situation will not occur at a speed like 20 mph and up. As a result, this modification will not hurt the performance much.

For the same reason, two single speed motors may be used for an even more simplified system, and in the system, MCM control both ISA and TM at the same time only at first and reverse gear. At the second gear and up, MCM only control one of the motors to drive or to generate electricity.

Preferred Hybrid Electric All-Wheel-Drive System Embodiment V—FIG. 5

The system comprises a heat engine (1), an integrated starter/alternator (ISA) (3), a motor control module (MCM) (7), two traction motors (TM) (9 and 15), and an electricity storage package (11). See FIG. 5.

The system is derived from Preferred Embodiment IV by eliminating the transmission ((5) in FIG. 4) and adding second traction motor (15) to drive the front wheels. In the system, the power of the engine (1) is converted into electric power by ISA (3), and the electric power is transmitted through wiring at low gears. Only at the high speed, clutch (6) is engaged, and the engine (1) provides torque to the wheels.

As those in Preferred system IV, ISA and TMs are two-speed motors. MCM controls electric switches (27, 29 and 31) to select motors' speeds. Under MCM's control, ISA and TMs together play the role of transmission to keep engine speed in the most effective speed range over the wide speed range of the vehicle.

Operation of the System—FIG. 5:

To start the engine (1), clutch (6) is disengaged, MCM (7) is disconnected from TMs (9) and (15) and only provides AC power to ISA (3) (Start position), and ISA turns the engine shaft.

When engine is in operation and the vehicle stands still, MCM can control ISA to generate electricity in the start position.

To accelerate the vehicle from standstill, clutch (6) remains disengaged, and MCM is connected to both ISA and TM. ISA is set at the high speed (27a), and TMs are set at the low speed (29b and 31b). MCM sets working frequency to optimize TMs output, and TMs provide torque to the wheels. Driven by the engine, ISA tends to rotate fast, and it generates electric power and keeps the engine from running very fast. The electric power generated by ISA has the same frequency as that from MCM, and TMs take all the electric power from both MCM and ISA and drive the vehicle.

When the vehicle is accelerated to a certain speed, say somewhere 15˜20 mph, the engine speed is high, and higher vehicle speed may cause the engine overspeed. To keep the engine from overspeed, MCM reduces the frequency by half, and then ISA and engine speed is reduced by half. At the same time, TMs are set to the high speed (29a and 31a) from the low speed (29b and 31b), so TMs' synchronous speed remains unchanged. Now both motors work at their own correct conditions, and the engine has room for higher vehicle speed.

When the engine goes up to high speed again, the vehicle speed is about 30˜40 mph, and higher speed will cause the engine overspeed. To keep the engine from overspeed, ISA is set to the low speed from the high speed, and its synchronous speed is reduced by half. Slowed down by the magnetic field at the synchronous speed, ISA will run at the half speed and pull down the engine speed. Since no change occurs to TM, it stays at its correct working condition. Clutch (6) is engaged after this speed setting, and the engine can deliver torque to the wheels, so the engine and TMs together drive the wheels.

When the vehicle cruises, the engine drives the vehicle by itself, and the two motors may either idle or generate electricity for the vehicle.

To decelerate the vehicle, MCM set such a frequency that the TMs' synchronous speed is lower that the mechanical speed. The two TMs will apply braking torque to the wheels and re-generate the vehicle's kinetic energy into electric energy for storage.

When the transmission is shifted to reverse, ISA is set at the high speed and TMs are set at the low speed, same as they are at very low forward speed, but two power wires of either ISA or TMS are swapped. Now ISA and TMs have different directions. Since ISA is attached to the engine, ISA runs in the same direction as before, but TMs will run in the opposite direction, driving the vehicle backward.

For single-rotor TMs, when a wheel or one pair of wheels slip, the related motor tends to run at synchronous speed and takes little energy. The other motor takes most of the electric power from MCM and ISA and drives the other pair of wheels.

For double-rotor TMs, when one wheel slips, the related rotor tends to run at synchronous speed and takes little energy. The other rotor of the motor takes most of the field energy in the motor and drives its wheel. When one pair of wheels slip, the two related rotors tends to run at the synchronous speed, and the motor consumes little energy. The other traction motor takes most of the power from MCM and ISA and drives the other pair of wheels.

With two double-rotor TMs, the system is able to drive the vehicle even if three out of four wheels slip. The system has very good performance under bad road conditions.

The major advantage of this system is that the mechanical transmission is eliminated, a big cost saving especially when a transmission is needed to be developed. Also the system provides smooth and quiet acceleration because no gear change is needed during acceleration.

The system also can be used for a two-wheel drive system by using only one traction motor (TM) to drive one pair of wheels.

This system can also use a small battery and MCM. The MCM only provides stimulating current to a big ISA, and ISA generate most power for TM(s). Now, the system is not a hybrid electric drive any longer, but it is a “pure” electric transmission system.

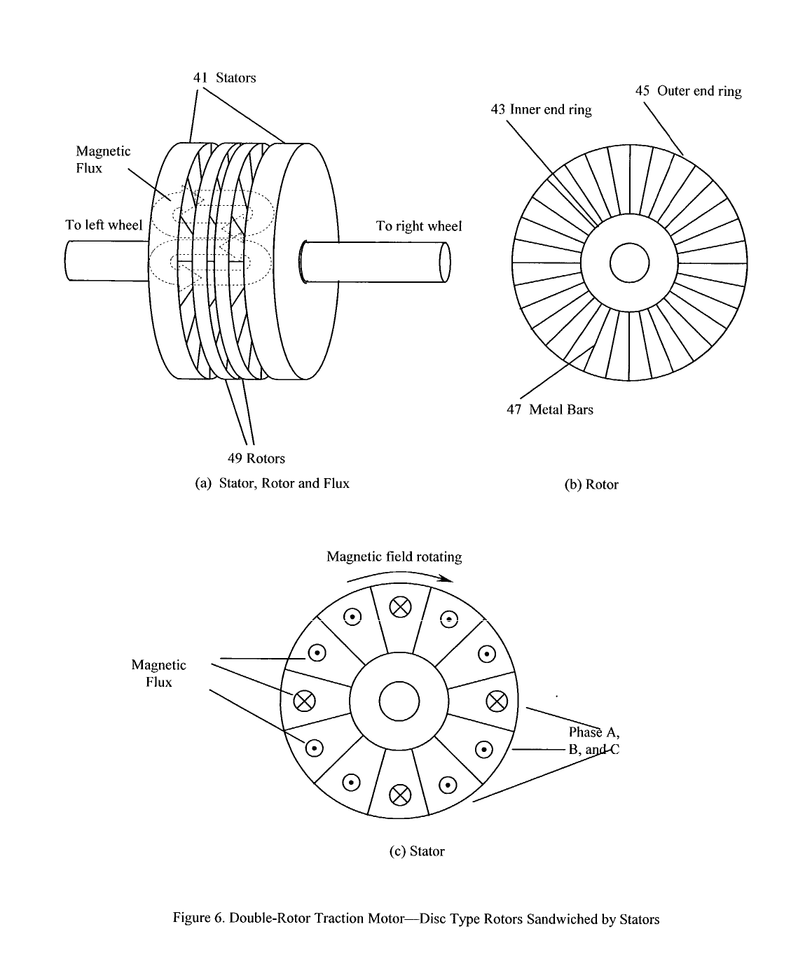

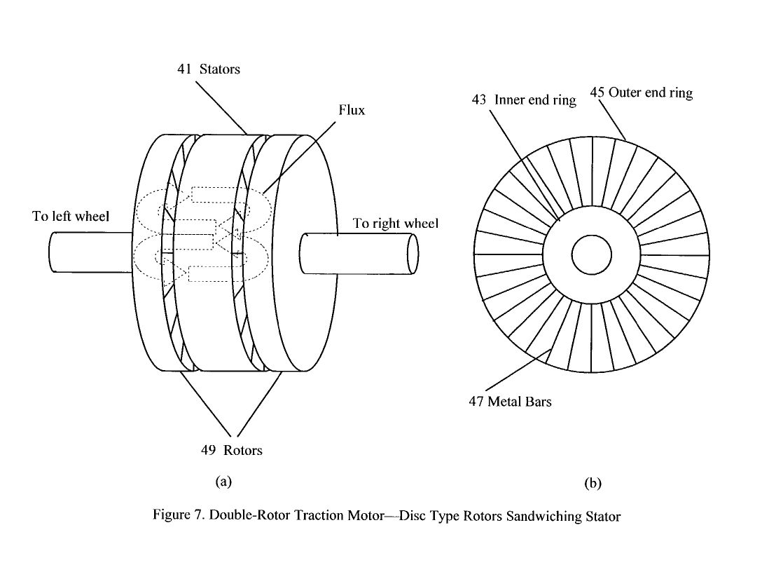

The Double-Rotor Traction Motor—FIG. 6 and FIG. 7

A double-rotor motor is provided as an optional traction motor for HEAWD system to enhance vehicle's performance and simplify the assembly of TM and the rear axle.

The motor is a poly-phase AC induction motor. It comprises a stator and two disk-type co-axis rotors. Each rotor has its own axle, and the two axles are not connected to each other, allowing two rotors to run at different speeds. See FIG. 6 and FIG. 7

The stator creates a common, axial magnetic field, and the field rotates about the motor axis when a poly-phase alternating current is applied to the stator winding. The rotating speed is the synchronous speed.

Each rotor has an iron core and radial metal bars (47) embedded in the core. The inner ends of the bars are connected to an inner end ring (43), and the outer ends are connected to an outer ring (45), forming the winding of the rotor, as shown in FIG. 6(b).

When the rotor speed is different from the synchronous speed, the magnetic field induces electric currents in the rotor winding and exerts Lorentz force on the carriers of the currents. Every element of the force on the end rings is on a line through the rotor axle and contributes nothing to the torque. The force on all the bars forms a torque to rotor axle, and the torque is trying to rotate the rotor at the synchronous speed.

When the rotors rotate slower than the field, the motor takes electric energy and converts it into mechanical one—torque. When the rotors rotate faster than the field, the motor takes mechanical energy from the rotor shafts and generates electricity.

When a driving torque is needed from TM, MCM sets such a frequency that the synchronous speed is higher than the rotors speeds, and then the motor will provide torque driving the vehicle. When braking effort is needed, MCM sets a synchronous speed lower than the rotors speeds, and then the motor will provide braking force to the wheels and generate electricity for battery to store.

Preferred Double-Rotor Motor Embodiments

A preferred double-rotor motor embodiment has a two-piece stator, and the two rotors are sandwiched by the two pieces of the stator, as shown in FIG. 6.

Each piece of the stator has poles and winding on the side facing the rotors. The magnetic flux created in a pole of phase A on the right, for example, goes through the air gaps and rotor cores, comes into the pole on the left. The flux turns its direction inside the stator core, and flows out of the adjacent poles of phase B and/or C on the left. The returning flux goes through the air gaps and rotors and comes into the poles of phase B and/or C on the right. The flux turns its direction again inside the stator core and comes to the original A pole, forming a close loop. See FIGS. 6(a) and (c).

An alternative double-rotor motor embodiment has a one-piece stator sandwiched by the two rotors, as shown in FIG. 7.

The stator has poles parallel to the motor axis, and each end of the poles faces one rotor, respectively. The magnetic flux created in a pole of phase A, for example, goes out of the left end of the pole, then goes through the air gap and comes into the left rotor; the flux turns its direction inside the rotor core and flows out of the rotor core; the returning flux goes through the air gap and the adjacent poles of phase B and/or C, and comes into the right rotor; the flux turns its direction again inside the rotor core and flows back into the original pole of phase A, forming a close loop. See FIG. 7(a).

In addition to the driving and braking functions, the double-rotors TM provides the function of an axle differential. Two rear wheels must be able to turn at different speed because the wheel on the outside of a turn must travel faster than the wheel on the inside of the turn. Usually, a rear axle assembly contains a differential, and the differential allows each of wheels to turn at correct speed independent of the other wheel. For the double-rotor TM, each rotor is connected to one wheel and mechanically independent from the other, so the two wheels can run at different speed. In another word, the function of a rear axle differential is integrated into the double-rotor traction motor.

The double-rotors TM also provide the function of a torque coupling device. In an assembly of two wheels connected to a differential, if one wheel slips, it will run very fast, and the other wheel can not drive the vehicle. To improve vehicle's performance during slip, a torque coupling device is used to deliver torque to the gripping wheel. In HEAWD system with a double-rotor TM, the rotor connected to the slipping wheel tends to run at the synchronous speed, a little faster than it is supposed to. When it reaches the synchronous speed, no current is induced in its winding, and the rotor takes little energy from the field. At the same time, the field becomes stronger, and the other rotor takes most of field energy and outputs stronger torque to the gripping wheel which in turn drives the vehicle. So, the double-rotor traction motor has the functions of a conventional traction motor plus a torque coupling device.

The rotor can have variations of cross section shape of the core. It may be a solid metal rotor. The solid metal rotor may have radial or skewed slots on the disk for containing the eddy current and flux leakage.

The double-rotor traction motor can be a multi-speed motor.

Conclusion:

From the description above, a number of advantages of this invention are present:

1. It provides hybrid electric drive systems with full all-wheel-drive functions.

2. Fuel economy is improved;

3. It saves significant cost by eliminating some expensive components compared with competitive systems;

4. It allows lower vehicle gravity center, improving vehicle's safety;

5. It provides good performance traction motor in bad road condition;

6. It eliminates the mechanical transmission in some embodiments;

The invention has been described in connection with several embodiments, and various modifications, variations and improvements will occur to those skilled in the art. It should be understood that all these that come within the true spirit and scope of the invention are included within the scope of the appended claims.

What is claimed is:

1. A hybrid electric all-wheel-drive system for a vehicle comprising:
a heat engine driving a first pair of wheels through a transmission;
a first motor starting and assisting said engine, and generating electric power;
means for switching over said first motor between said engine shaft and said transmission output shaft;
a second motor driving a second pair of wheels;
an electric energy storage device; and
a motor control module providing electric current to and controlling said first motor and said second motor.

2. A hybrid electric all-wheel-drive system for a vehicle as specified in claim 1 wherein said means comprises a first clutch capable of connecting said first motor to said engine shaft, and a second clutch capable of connecting said first motor to said transmission output shaft.

3. A hybrid electric all-wheel-drive system for a vehicle comprising:
a heat engine driving a first pair of wheels through a transmission;
a first motor starting said engine and generating electric power;
a rectifier converting the electric power generated by said first motor into direct current;
a second motor driving a second pair of wheels;
a motor control module providing electric current to and controlling said first motor and said second motor; and
an electric energy storage device.

4. A hybrid electric all-wheel-drive system for a vehicle comprising:
a heat engine driving a first pair of wheels through a transmission;
said transmission including a clutch on the output shaft, said clutch connecting said transmission output shaft to said first pair of wheels;
a first motor starting and assisting said engine and generating electric power, said first motor being connected to said transmission output shaft;
a second motor driving a second pair of wheels; a motor control module providing electric current to and controlling said first motor and said second motor; and
an electric energy storage device.

5. A hybrid electric all-wheel-drive system for a vehicle comprising;
a heat engine driving a first pair of wheels through a transmission;
a first multi-speed induction motor being connected to said engine shaft, said first motor starting and assisting said engine and generating electric power;
a second multi-speed induction motor driving a second pair of wheels;
said transmission enabling the two motors to remain electrically synchronous to each other by setting their speeds and directions when said transmission changes gear;
means for setting speeds of the two motors, and direction of one of the two motors;
a motor control module providing electric current to and controlling said first motor and said second motor; and
an electric energy storage device.

6. The hybrid drive system as specified in claim 5, wherein said first motor and said second motor are of single-speed, the two motors are able of being electrically synchronous at the reverse and first gear of said transmission, said motor control module provides electric current to and controls both said first motor and said second motor simultaneously only when the two motors are electrically synchronous to each other, and said motor control module provides electric current to and controls one of the two motors in any other situations.

7. The hybrid drive system as specified in claim 5, wherein said first motor is a single-speed motor, the two motors are able of being electrically synchronous at the reverse and low gears of said transmission, said motor control module provides electric current to and controls both said first motor and said second motor simultaneously only when the two motors are electrically synchronous, and said motor control module provides electric current to and controls one of the two motors in any other situations.

8. The hybrid drive system as specified in claim 5, wherein said second motor is a single-speed motor, the two motors are able of being electrically synchronous at the reverse and low gears of said transmission, said motor control module provides electric current to and controls both said first motor and said second motor simultaneously only when the two motors are electrically synchronous, and said motor control module provides electric current to and controls one of the two motors in any other situations.

9. The hybrid drive system as specified in claim 5 wherein said transmission is eliminated, a third motor drives said first pair of wheels, said third motor is similar to and runs in the same direction as said second motor, and said motor control module provides electric current to and controls the three motors.

10. The hybrid drive system as specified in claim 9 wherein said engine is connected to one pair of the wheels only when said first motor is set at the low speed and said second motor and said third motor are set at the high speed, so that said engine is able of driving the vehicle for cruise.

11. The hybrid drive system as specified in claim 9 wherein said engine is connected to one pair of the wheels when said motor control module is only connected to either said first motor or said second motor and said third motor, so that said engine is able of driving the vehicle for cruise.

12. The hybrid drive system as specified in claim 5 wherein said transmission is eliminated, and said first pair of wheels is not driven.

13. The hybrid drive system as specified in claim 12 wherein said engine is connected to one pair of the wheels only when said first motor is set at the low speed and said second motor is set at the high speed, so that said engine is able of driving the vehicle for cruise.

14. The hybrid drive system as specified in claim 12 wherein said engine is connected to one pair of the wheels when said motor control module is only connected to either said first motor or said second motor, so that said engine is able of driving the vehicle for cruise.

15. An poly-phase alternating current induction traction motor for a hybrid electric all-wheel-drive system comprising:
a two-piece stator;
two co-axis rotors being sandwiched by the two pieces of said stator, each of said rotors having a predetermined cross section shape, disk-like iron core and metal bars embedded in said core, each of said rotor having at least one outer end ring and one inner end ring, each end of said metal bar being connected to one said end ring, respectively;
each of said rotors including an output shaft, said rotors being independent of each other whereby the two rotors can run at different speeds, and one of said rotors picks more power when the other of said rotors has less load.

16. The traction motor as specified in claim 15 wherein said stator has only one piece and is sandwiched by the two rotors.

17. The traction motor as specified in claim 15 wherein said motor is a multi-speed motor.

18. The traction motor as specified in claim 16 wherein said motor is a multi-speed motor.

19. The traction motor as specified in claim 15 wherein said rotors are solid iron, disk-type rotors.

20. The traction motor as specified in claim 19 wherein said rotors have slots to contain eddy current and magnetic flux leakage.

21. The traction motor as specified in claim 15 wherein said motor has two co-axis cylinder-type rotors and is a multi-speed motor.
